(19) United States
(12) Patent Application Publication
(10) Pub. No.: US 2015/0208689 A1
(43) Pub. Date: Jul. 30, 2015

(54) MEAT PET FOOD PRODUCTS LACKING WHEAT GLUTEN

(71) Applicant: NESTEC SA, VEVEY (CH)

(72) Inventors: Jean Luz Rayner, St. Joseph, MO (US); Michael J. Saylock, Kansas City, MO (US); Koraljka RADE-KUKIC, SAVIGNY (CH); Hugo GLORIA-HERNANDEZ, Lausanne (CH); Julien Hugo, Lausanne (CH)

(21) Appl. No.: 14/607,609

(22) Filed: Jan. 28, 2015

Related U.S. Application Data
(60) Provisional application No. 61/933,000, filed on Jan. 29, 2014.

(51) Int. Cl. A23K 1/10; A23K 1/18; A23K 1/16

(52) U.S. Cl. CPC A23K 1/103; A23K 1/10; A23K 1/1631; A23K 1/1866

(57) ABSTRACT

Meat pet food products that lack wheat gluten and methods for making same are provided. The meat pet food products and methods for making same use (i) canola protein isolate, (ii) a combination of flaxseed meal and canola protein isolate, or (iii) a combination of flaxseed meal and egg white to replace the wheat gluten without negatively affecting the product structure, appearance and palatability. The meat pet food products are preferably emulsified products, such as meat analog chunks. The egg white is preferably spray dried egg white. The canola protein isolate, combination of flaxseed meal and canola protein isolate, or combination of flaxseed meal and egg white can replace the wheat gluten in a 1:1 weight basis or less. The meat pet food product does not contain wheat gluten and preferably does not contain any gluten.

### CROSS REFERENCE TO RELATED APPLICATIONS

This application claims priority to U.S. Provisional Application No. 61/933,000 filed Jan. 29, 2014, the disclosure of which is incorporated herein by this reference.

### BACKGROUND

The present disclosure generally relates to pet foods. More specifically, the present disclosure relates to meat pet food products lacking wheat gluten and also relates to methods for making such meat pet food products.

Wheat gluten, such as vital wheat gluten, is used in pet food products to improve emulsion stability and binding, impart flavor, and reduce formulation costs. For example, the inclusion of wheat gluten in a meat emulsion enables use of meat materials having a protein to fat ratio and myosin to total protein ratio which would otherwise be of marginal acceptability for use in preparing meat emulsion products.

Due to the viscoelastic properties of wheat gluten, it is critical to the aesthetic appearance of pet food products, especially those products made by processes that involve high temperature, high shear and/or high pressure. For example, wheat gluten advantageously builds viscosity for processing and also stretches and contracts under high temperatures and pressures, and both of these properties are particularly beneficial for emulsified food products.

Some pets can be sensitive to gluten. Consumption of gluten in sensitive pets can lead to chronic gastrointestinal upset, dermatitis, and chronic ear infections. Moreover, even if a pet is not sensitive to gluten, over-consumption of this grain can have negative health effects. For example, the natural diet of cats and dogs includes a high level of protein, fats and water and low levels of carbohydrates, and the optimal diet for a dog or cat closely resembles the natural diet. In this regard, a diet heavy in grains promotes insulin production and the production of inflammatory chemicals, and over-production of insulin hinders the body from maintaining a correct weight and can lead to diabetes and other problems.

Several gluten-replacement ingredients have been tested individually in emulsified pet foods, including plasma, soy meals, sodium caseinate, whey protein concentrate, dried egg white, gums, cellulose, canola meal, pea protein, and tubermine. The resultant pet food was not in the form of good chunks. The chunks were soft and had an excessive amount of fines, and the texture was very different from current emulsified meat analog chunks.

### SUMMARY

The present disclosure provides meat pet food products lacking wheat gluten and also provides methods for making such meat pet food products. The pet food products and methods use (i) canola protein isolate, (ii) a combination of flaxseed meal and canola protein isolate, or (iii) a combination of flaxseed meal and egg white to replace the wheat gluten without negatively affecting the product structure, appearance and palatability.

The meat pet food product can be a meat emulsion product having a realistic meat-like image and produced by forming a meat emulsion containing protein and fat, comminuting and heating the emulsion to a temperature of at least 132° F., introducing the emulsion into a processing zone where the emulsion is subjected to a pressure of at least 100 psi, and discharging the emulsion. The canola protein isolate, combination of flaxseed meal and canola protein isolate, or combination of flaxseed meal and egg white can be added to the meat material before and/or after the meat material is emulsified.

The meat pet food product can be fabricated fish chunks having the appearance and texture of real fish and produced by creating a mixture of the ingredients, including the canola protein isolate, combination of flaxseed meal and canola protein isolate, or combination of flaxseed meal and egg white; blending the mixture while increasing the temperature to from about 135 to about 170° C.; and cooling the mixture to a temperature to from about 60 to about 95° C.

Accordingly, in a general embodiment, the present disclosure provides a pet food product comprising emulsified meat material and an ingredient selected from the group consisting of (i) canola protein isolate, (ii) a combination of flaxseed meal and canola protein isolate, and (iii) a combination of flaxseed meal and egg white, and the product does not contain wheat gluten.

In an embodiment, the pet food product comprises at least 29% protein by weight of the product.

In an embodiment, the pet food product comprises up to 15% fat by weight.

In an embodiment, the emulsified meat material is from at least one source selected from the group consisting of poultry, beef, pork and lamb, and the ingredient is present in an amount of about 5% to about 55% by weight of the product.

In an embodiment, the emulsified meat material comprises surimi, and the ingredient is present in an amount from about 2 to about 10% of the product.

In an embodiment, the product is gluten-free.

In another embodiment, the present disclosure provides a method of making a pet food product that does not contain wheat gluten. The method comprises: performing an emulsification of meat material to form a meat emulsion that does not contain wheat gluten; comminuting and heating the meat emulsion; subjecting the meat emulsion to an increased pressure; and adding to the meat material, at a time selected from the group consisting of before the emulsification, after the emulsification, and a combination thereof, an ingredient selected from the group consisting of (i) canola protein isolate, (ii) a combination of flaxseed meal and canola protein isolate, and (iii) a combination of flaxseed meal and egg white.

In an embodiment, the meat material is from at least one source selected from the group consisting of poultry, beef, pork and lamb, and the ingredient is present in an amount of about 5% to about 55% by weight of the emulsion.

In an embodiment, the meat material comprises surimi, and the ingredient is present in an amount from about 2 to about 10% of the emulsion.

In an embodiment, the heating is performed at a temperature of at least 132° C.

In an embodiment, the increased pressure is at least 100 psi.

In an embodiment, the method further comprises a step performed after the increased pressure and selected from the group consisting of (i) dicing the meat emulsion into chunks and blending the chunks with another pet food product, (ii) cutting the meat emulsion into pieces that are dried to a moisture content less than 12% and then coated with flavorants, (iii) forming shelf-stable soft treats by cutting the meat emulsion into pieces that are dried to a moisture content less than 25% and then coating the pieces, and (iv) dicing the meat emulsion into chunks, drying the chunks to a moisture content less than 12%, and blending the dried chunks with another pet food product.

In an embodiment, the meat emulsion is gluten-free.

In another embodiment, the present disclosure provides a method of making a pet food product that does not contain wheat gluten. The method comprises replacing wheat gluten in a meat emulsion with an ingredient selected from the group consisting of (i) canola protein isolate, (ii) a combination of flaxseed meal and canola protein isolate, and (iii) a combination of flaxseed meal and egg white, and forming the pet food product that does not contain wheat gluten by processing the meat emulsion.

In an embodiment, the ingredient is substituted for the wheat gluten in a 1:1 weight ratio.

In an embodiment, the meat emulsion is gluten-free.

In another embodiment, the present disclosure provides a method of making a pet food product that does not contain wheat gluten comprising: forming a mixture comprising surimi and an ingredient selected from the group consisting of (i) canola protein isolate, (ii) a combination of flaxseed meal and canola protein isolate, and (iii) a combination of flaxseed meal and egg white, and the mixture does not contain wheat gluten; blending the mixture while increasing a temperature of the mixture; and cooling the blended mixture to produce fish chunks that do not contain wheat gluten.

In an embodiment, the temperature is increased to about 135 to about 170° C. during the blending.

In an embodiment, the blended mixture is cooled to a temperature from about 60 to about 95° C.

In an embodiment, the mixture is gluten-free.

In an embodiment, the ingredient is present in an amount from about 2 to about 10% of the mixture.

An advantage of the present disclosure is to provide a meat pet food product lacking wheat gluten.

Another advantage of the present disclosure is to provide a meat pet food product that is gluten-free.

Still another advantage of the present disclosure is to provide a method for making a meat pet food product lacking wheat gluten.

Yet another advantage of the present disclosure is to replace the wheat gluten in a meat pet food product without negatively affecting the product structure and appearance.

An additional advantage of the present disclosure is to replace the wheat gluten in a meat pet food product while maintaining the textural attributes thereof, for example a striated appearance for meat-like products and a layered and flaky appearance for fish-like products.

Another advantage of the present disclosure is to replace the wheat gluten in a meat pet food product while allowing processing conditions of high temperature, high shear and/or high pressure.

Still another advantage of the present disclosure is to replace the wheat gluten in a meat pet food product while maintaining the palatability of the pet food product.

Yet another advantage of the present disclosure is to replace the wheat gluten in a meat pet food product that can be used in a multitude of forms, including moist, semi-moist and dry pet food; a variety of sizes and shapes; and alone or in a blend with another pet food product.

Another advantage of the present disclosure is to provide a method for manufacturing a meat emulsion product in which the wheat gluten is replaced.

Yet another advantage of the present disclosure is to replace the wheat gluten in a meat emulsion product that simulates muscle meat.

Still another advantage of the present disclosure is to replace the wheat gluten in a meat emulsion product that has a very realistic, meat-like appearance.

Another advantage of the present disclosure is to replace the wheat gluten in a meat emulsion product that has a very realistic meat-like image and retains integrity and shape when subjected to commercial canning and sterilization procedures, such as those required in the production of canned high-moisture food products.

Yet another advantage of the present disclosure is to replace the wheat gluten in a meat emulsion that can simulate poultry, pork, beef, fish or other meat.

An additional advantage of the present disclosure is to replace the wheat gluten in a meat emulsion product while maintaining a strong bite/mouthfeel that is not pasty, mushy or brittle.

Another advantage of the present disclosure is to replace the wheat gluten in a meat pet food product without negatively impacting the production process.

Additional features and advantages are described in, and will be apparent from, the following Detailed Description and the Figures.

### BRIEF DESCRIPTION OF THE DRAWINGS

FIG. 1 is a table showing the formulations of meat analog chunks produced in Examples 1-6.

FIG. 2 is a table showing the formulations of fish analog chunks used in Examples 7 and 8.

FIG. 3 is a photograph of the meat analog chunks produced in Example 1.

FIG. 4 is a photograph of the meat analog chunks produced in Example 2.

FIG. 5 is a photograph of the meat analog chunks produced in Example 6.

FIG. 6 is a photograph of the fish analog chunks produced in Example 7.

FIG. 7 is a photograph of the fish analog chunks produced in Example 8.

### DETAILED DESCRIPTION

All percentages expressed herein are by weight of the total weight of the composition unless expressed otherwise. When reference is made to the pH, values correspond to pH measured at 25° C. with standard equipment. As used herein, “about” is understood to refer to numbers in a range of numerals, for example the range of −10% to +10% and preferably −5% to +5% of the referenced number. Moreover, all numerical ranges herein should be understood to include all integers, whole or fractions, within the range.

The term “pet” means any animal which could benefit from or enjoy the compositions provided by the present disclosure. The pet can be an avian, bovine, canine, equine, feline, hicrine, lupine, murine, ovine, or porcine animal. The pet can be any suitable animal, and the present disclosure is not limited to a specific pet animal. The term “companion animal” means a dog or a cat.

The term “pet food” means any composition intended to be consumed by a pet. The term “chunks” means a plurality of separate food bodies, and preferably the food bodies are made by slicing a meat emulsion into separate pieces. “Meat analogs” means meat emulsion products that resemble chunks or pieces of natural meat in appearance, texture, and physical structure.

“Dry food” is pet food having a water activity less than 0.65. “Kibbles” are pellets of dry pet food. “Semi-moist food” and “intermediate moisture food” is pet food having a water activity from 0.65 to 0.8. “Wet food” is pet food having a water activity more than 0.8.

The term “surimi” means a fish-based food product obtained from deboned fish flesh which has been washed repeatedly then decanted, producing a concentrated stabilized source of myofibrillar proteins in the form of a paste, to which cryoprotectants are added prior to freezing. Various quality grades (A, AA, AAA, FA, KA, SA, RA, KB, etc.) of surimi can be used to produce fabricated fish chunks. Quality grades are determined by: (1) color/whiteness (brightness), which is directly related to the amount of washing, and (2) gel strength. The higher the quality grade, the higher the whiteness value (more washing), and the higher the gel strength measurement due to myofibillar protein concentration.

As used herein and in the appended claims, the singular form of a word includes the plural, and vice versa, unless the context clearly dictates otherwise. Thus, the references “a,” “an” and “the” are generally inclusive of the plurals of the respective terms. For example, reference to “a compound” or “a method” includes a plurality of such “compounds” or “methods.”

Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein.

The inventors surprisingly found that (i) canola protein isolate, (ii) a combination of flaxseed meal and canola protein isolate, or (iii) a combination of flaxseed meal and egg white can replace the wheat gluten in an emulsified meat pet food product without negatively affecting the product structure, appearance and palatability. Accordingly, the present disclosure provides meat pet food products lacking wheat gluten and also provides methods for making such meat pet food products. The meat pet food products are preferably emulsified products, such as meat analog chunks. The egg white in the combination of flaxseed meal and egg white is preferably spray dried egg white.

The canola protein isolate, combination of flaxseed meal and canola protein isolate, or combination of flaxseed meal and egg white can replace the wheat gluten in a 1:1 basis or less. The meat pet food product does not contain wheat gluten and preferably does not contain any gluten. Non-limiting examples of suitable canola protein isolate, flaxseed meal, and egg white are ISOLEXX® by BioExx Specialty Proteins Ltd., OPTISOL® 5300 by Glanbia Nutritionals, Inc., and spray dried angel or standard egg whites by Sonstegard Foods Co., respectively.

The amount of the canola protein isolate, combination of flaxseed meal and canola protein isolate, or combination of flaxseed meal and egg white may vary from about 5% to about 35% by weight of the emulsified meat pet food product, depending on such factors as the intended use of the product, the quality of meat material used in the emulsion, ingredient cost considerations, and the like. In a preferred embodiment, the amount of the canola protein isolate, combination of flaxseed meal and canola protein isolate, or combination of flaxseed meal and egg white is between about 5% and about 35% by weight, preferably 25 and about 35% by weight, for example from about 28% to about 31% by weight. Generally, as the fat content and/or moisture content of the meat material used are increased, the amount of the canola protein isolate, combination of flaxseed meal and canola protein isolate, or combination of flaxseed meal and egg white in the emulsion is increased accordingly. In an embodiment, the meat pet food product does not contain gluten and comprises about 20% flaxseed meal and about 8% spray dried egg white.

Non-limiting examples of suitable meat materials include meat (i.e. skeletal tissue and non-skeletal muscle) from mammals, fish and fowl (e.g. poultry, beef, pork, lamb and fish, especially those types of meats suitable for pets) and also include meat by-products (i.e. the non-rendered clean parts, other than meat, derived from slaughtered mammals, fowl or fish). Preferably, the meat material is non-dehydrated meat and/or meat by-products, including frozen materials. More specific non-limiting examples include whole-carcass beef and mutton, lean pork trim, beef shanks, veal, beef and pork cheek meat; meat by-products such as lips, tripe, hearts, and tongues; and meat by-products approved for use in animal foods, such as mechanically deboned beef, chicken, or fish, beef and pork liver, lungs, kidney, and the like.

In an embodiment, the meat material can be a combination of three to five different types of meats and/or meat by-products and can be formulated to contain a maximum of about 25% by weight of fat; preferably below about 15% fat; more preferably below about 13% fat; even more preferably below about 9% fat, for example about 4% to about 9% fat; and most preferably not more than 6% fat, for example about 4% to about 6% fat. In an embodiment, the meat pet food product can comprise at least 29% protein by weight, for example 29% to 31% protein by weight.

In a preferred embodiment, the meat pet food product is a complete and nutritionally balanced pet food. The meat pet food product can be an extruded food product and, in an embodiment, can be for companion animals. In an embodiment, the meat pet food product is a dry cat food or a dry dog food, such as a kibble. In another embodiment, the meat pet food product is a semi-moist cat food or a semi-moist dog food. In yet another embodiment, the meat pet food product is a moist cat food or a moist dog food.

In an embodiment, the meat pet food product can be diced to suitable size and blended with gravy, sauce, gel, or pate. The blend containing the meat pet food product can be filled and hermetically sealed in a container, such as a can, a pouch, or a glass jar. Then the container can be retort sterilized.

In another embodiment, the meat pet food product can be larger pieces made into to pet treats by drying (e.g., to a moisture <12%) and then coating with flavorants.

In yet another embodiment, shelf-stable soft treats can be made with suitably sized larger pieces of the meat pet food product by drying (e.g., to a moisture <25%) and then coating with flavorants, preservatives and humectants (Aw<0.7). The soft treats can be used in this form or can be blended in suitable proportions with dry expanded kibbles coated with flavorants.

In yet another embodiment, the meat pet food product can be diced to kibble size pieces, such as chunks; dried (e.g., to a moisture <12%); and then blended with dry expanded kibbles. The blend can be coated with flavorants or instead the dried diced chunks and the expanded kibbles can be coated separately and then blended.

Non-limiting examples of suitable flavorants include yeast, tallow, rendered animal meals (e.g., poultry, beef, lamb, and pork), flavor extracts or blends (e.g., grilled beef), spices, and the like. Suitable spices include parsley, oregano, sage, rosemary, basil, thyme, chives and the like.

The canola protein isolate, combination of flaxseed meal and canola protein isolate, or combination of flaxseed meal and egg white are dry proteinaceous materials that improve emulsion stability and binding. One or more additional dry proteinaceous materials can be used in the meat emulsion with the canola protein isolate, combination of flaxseed meal and canola protein isolate, or combination of flaxseed meal and egg white. Non-limiting examples of suitable additional dry proteinaceous materials include soy flour, soy protein concentrate, soy protein isolate, egg albumin, and nonfat dry milk. The total amount of any additional dry proteinaceous material and the canola protein isolate, combination of flaxseed meal and canola protein isolate, or combination of flaxseed meal and egg white may vary from about 5% to about 35% by weight of the emulsion, preferably between about 25 to about 35% by weight.

The present disclosure also provides methods for making a meat pet food product lacking wheat gluten. The methods do not use wheat gluten in any step and preferably do not use any gluten in any step. The meat pet food product can be made using any process known to one having ordinary skill in the art. For example, the meat pet food product can be made using any of the processes disclosed in U.S. Pat. No. 7,736,686 issued Jun. 15, 2010 to Dingman et al.; U.S. Pat. No. 6,649,206 issued Nov. 18, 2003 to Dingman et al.; U.S. Pat. No. 6,379,738 issued Apr. 30, 2002 to Dingman et al.; and PCT Application Publication No. WO 2013/015944 (App. No. PCT/US2012/044889) published Jan. 31, 2013 to Cully et al., all assigned to the assignee of the present application and hereby incorporated by reference in their entireties.

For example, a preferred embodiment of the pet food is a meat emulsion product having visible small diameter fibers that provide a realistic meat-like appearance, and the meat emulsion product can be made by formulating, grinding and emulsifying a mixture of natural meat materials. In an embodiment, the realistic meat-like appearance is provided by a plurality of strands of fibers that are linearly arranged in bundles in the pet food product.

In an embodiment, the meat material is emulsified using a high speed blender that reduces the size of the meat materials and any added ingredients using mixing and shearing forces further detailed below.

At least a portion of the canola protein isolate, combination of flaxseed meal and canola protein isolate, or combination of flaxseed meal and egg white can be added to the meat material after the meat material has been emulsified in a first step. The emulsified meat materials comprising the canola protein isolate, combination of flaxseed meal and canola protein isolate, or combination of flaxseed meal and egg white can subsequently be further mixed and subjected to another emulsification step involving high speed blending and shearing forces. Additionally or alternatively, at least a portion of the canola protein isolate, combination of flaxseed meal and canola protein isolate, or combination of flaxseed meal and egg white can be added to the meat materials prior to the first emulsification.

At least a portion of any additional dry proteinaceous material can be added to the meat material after the meat material has been emulsified in a first step. Additionally or alternatively, at least a portion of any additional dry proteinaceous material can be added to the meat materials prior to the first emulsification.

Additives used in conventional meat emulsion products may be mixed with the meat material prior to and/or after emulsification and included in the meat emulsion product. Non-limiting examples of suitable additives include salt, seasoning, sugar, and the like in amounts sufficient to provide the product with desired taste characteristics. In addition, minor amounts of other dry ingredients such as, for example, vitamins, minerals, flavors, colors, and the like, may also be added to the meat emulsion.

Non-limiting examples of suitable vitamins include vitamin A, any of the B vitamins, vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like.

Non-limiting examples of suitable colors include FD&C colors, such as blue no. 1, blue no. 2, green no. 3, red no. 3, red no. 40, yellow no. 5, yellow no. 6, and the like; natural colors, such as caramel coloring, mulatto, chlorophyllin, cochineal, betanin, turmeric, saffron, paprika, lycopene, elderberry juice, pandan, butterfly pea and the like; titanium dioxide; and any suitable food colorant known to the skilled artisan.

While the formulation of the meat emulsion may vary widely, the emulsion should have a protein to fat ratio sufficient to form a firm meat emulsion product upon coagulation of the protein with no sign of emulsion instability. The protein content of the emulsion should enable the emulsion, upon being heated to a temperature above the boiling point of water, to coagulate and form a firm emulsion product within a short period of time after being heated to such a temperature, for example within about 5 minutes and preferably within 3 minutes. Thus, in an embodiment, the meat materials and the additives, including the dry proteinaceous material, are mixed together in proportions such that the meat material is present in an amount of between about 50% to 75% by weight and preferably from about 60% to about 70% by weight of the meat emulsion. In a preferred embodiment, the starting ingredients for the meat emulsion comprise about 29 to about 31% by weight protein and up to about 15% fat by weight, preferably about 4 to about 9% fat by weight, and more preferably about 4 to about 6% fat by weight. The resultant meat emulsion product preferably has a substantially similar profile to that of the starting ingredients; however, if gravy or broth is added to the product, this profile could change due to the moisture, protein and/or fat content of the gravy/broth.

Preferably, the meat emulsion is formulated to contain between about 45% to about 80% by weight moisture, more preferably between about 49% to about 56% by weight moisture, most preferably between about 52% to about 56% by weight moisture, by weight of the meat emulsion. The exact concentration of water in the emulsion will depend on the amount of protein and fat in the emulsion.

The meat mix can be passed through a grinder to reduce the meat material into pieces of substantially uniform size. Preferably the grinder is equipped with a 1 cm or smaller grinding plate, although satisfactory results may be obtained by grinding the meat to a particle size larger than 1 cm. If the meat materials to be used are in a frozen condition, the frozen meat materials should be pre-broken or cut into pieces to reduce the size of the pieces entering the grinder. The size of the pieces will depend on the size of the meat grinder intake, but an embodiment of the process comprises cutting the frozen meat material into pieces that are about 10 cm square.

After grinding, the mix of meat particles can be conveyed to a mixing tank in which the meat is mixed until uniform (e.g., homogeneous) and preferably heated to a temperature between about −1° C. to about 7° C., such as by hot water jacketing, steam injection, or the like to facilitate pumping of the meat mix.

The uniform mix of ground meat particles can then be comminuted under conditions which emulsify the meat material and form a meat emulsion in which the protein and water of the meat mixture form a matrix that encapsulates the fat globules. The meat material may be emulsified by any procedure and equipment known to one having ordinary skill in the art, such as by using a mixer, blender, grinder, silent cutter chopper, emulsion mill, or the like which is capable of breaking up and dispersing the fat as globules in the protein slurry to form an emulsion.

Typically the temperature of the meat emulsion increases during the emulsification process. This heating of the meat emulsion is not objectionable as long as the temperature does not increase to the point that protein denaturation begins to occur at an undesirable rate at this stage of the process. The temperature of the meat mixture during emulsification preferably is maintained below about 49° C. to minimize protein denaturing at this stage of the process. In a preferred embodiment, the meat material is passed through an emulsion mill to emulsify the meat material with the emulsion heated to a temperature between about 10° C. to about 49° C., preferably between about 21° C. to about 38° C.

At least a portion of the additives to be incorporated in the meat emulsion may be added to the meat mix prior to emulsification. Alternatively or additionally, at least a portion of the additives may be added to the meat mix after emulsification of the meat. The addition of the dry proteinaceous material, namely the canola protein isolate, combination of flaxseed meal and canola protein isolate, or combination of flaxseed meal and egg white, and any additional dry proteinaceous material, increases the viscosity of the emulsion. Therefore, better emulsification is obtained when the meat mix is emulsified before the addition of the dry proteinaceous material, which results in the formation of a viscous meat emulsion.

The meat emulsion can be comminuted again to increase the fineness of the emulsion, for example in a second emulsification step, and can be rapidly heated to a temperature above the boiling point of water. At such a temperature, the coagulation of protein in the emulsion proceeds so rapidly that the emulsion is set and a firm emulsion product formed within a very short period of time, for example within 20 seconds or less.

Rapidly heating the viscous meat emulsion to a temperature above the boiling point of water, generally between about 120° C. to about 165° C., preferably between about 120° C. to about 150° C., more preferably between about 132° C. to about 154° C., and most preferably between about 132° C. to about 141° C., results in the protein in the emulsion coagulating to set the emulsion and form a firm emulsion product. The coagulation can occur within about five minutes after heating and typically from a few seconds to about three minutes after heating. At this stage in the process, the emulsion can be under a pressure of about 40 to about 500 psi, preferably between about 40 to about 500 psi, more preferably 60 to 350 psi, and most preferably 60 to 100 psi. The high temperature, along with increased pressures, provide fiber definition to the product. Surprisingly, the higher the product temperature and pressure, the better the fiber development, such as linear alignment of fibers.

Preferably, the emulsion is processed in equipment wherein the emulsion is heated to such elevated temperatures while it is being comminuted such as by mechanical heating and/or steam injection. According to a preferred embodiment, the viscous meat emulsion, which is at a temperature of between about 30° C. to about 40° C., is pumped through an emulsion mill in which the meat emulsion is subjected to shearing to increase the fineness of the emulsion and almost simultaneously heat the emulsion to between about 120° C. to about 165° C., preferably between about 120° C. to about 150° C., more preferably 132° C. to about 154° C., and most preferably about 132° C. to about 141° C., through rapid mechanical heating and/or steam injection. Thus, the emulsion preferably is heated to such elevated temperatures in a period of less than about 60 seconds.

When the emulsion has been heated to such an elevated temperature in this manner, preferably further significant shearing and cutting of the emulsion is avoided. Control of the emulsion temperature within the desired range can be effected by adjusting such factors as the feed rate into the emulsion mill, the rotational speed of the emulsion mill, and the like, and can readily be determined by those skilled in the art.

The hot meat emulsion can be transferred with a positive displacement pump, for example a gear or lobe pump. The hot meat emulsion can be transferred to a holding tube that defines a confined processing zone for a heat exchanging step. In an embodiment, the product is pumped at high pressures of at least about 80 psi or higher. For example, the product can be pumped at pressures of about 80 psi to about 600 psi, preferably about 100 psi to about 500 psi, more preferably 140 psi to about 350 psi, and most preferably 140 psi to about 200 psi, into the processing zone. The product can also be pumped at pressures higher than 600 psi using suitable equipment.

At such high pressures, the process can operate at about the upper pressure design limit of the emulsifier equipment (235 psi max). For this reason, preferably a gear pump (pressure limit of 500 to beyond 2500 psi.) is close-coupled directly after the emulsifier. The gear pump can allow the emulsifier to develop the high temperature without the high pressure, and the pressure can be developed after the pump, thereby reducing the pressure in the emulsifier housing to 60 to 100 psi.

The confined processing zone preferably is in the form of an elongated tube, heat exchanger or similar device where flashing of the product moisture can be controlled. The emulsion can be retained in the confined processing zone at a pressure above the vapor pressure of the emulsion until the protein in the meat emulsion has coagulated sufficiently to set the emulsion and form a firm emulsion product, which retains shape and structure when discharged from the confined processing zone. At such elevated temperature, protein coagulation can proceed at a very rapid rate.

While the period of time required for the hot emulsion to set sufficiently to form a firm product will depend on a number of factors, such as the temperature to which the emulsion is heated and the amount and type of protein in the emulsion, a residence time of between a few seconds to about three minutes, and usually between about 1.0 to about 1.5 minutes, in the elongated tube can allow the protein to sufficiently coagulate and form a firm emulsion product which will retain shape, integrity, and physical characteristics. The residence time in the elongated tube can be controlled by adjusting the flow rate of the emulsion to the elongated tube and/or by adjusting the length of the elongated tube.

The structure of the elongated tube can help to create the fiber structure of the product. In an embodiment, the elongated tube has a reduced cross-sectional diameter along its length such that the circumference of the tube is smaller as the product proceeds into the tube. In practice, tubes having a length between about 2.5 m and about 8.0 m, preferably between about 3.5 m and about 8.0 m, more preferably 3.0 m to 6.0 m, and most preferably 4.0 m to 6.0 m, and having an internal diameter between about 12 mm and about 75 mm can function satisfactorily to form a firm emulsion product. Because the tube has a cross-sectional diameter that decreases along its length, or a portion thereof, the product entering the tube is squeezed as the product flows through the tube. The flow rate and differing pressures on the product help create the fiber structure. By way of example, a tube material can narrow through a conical reducer to outlet having a smaller diameter relative to the inlet. Tubes of various cross-sectional shapes may be used, such as circular, square, rectangular, and the like as long as a reduction in the diameter is provided.

Preferably, the tube is cooled to decrease the temperature of the product as the product is forced through the tube. The tube can be cooled by an external jacket or other means. A rectangular or similar shaped tube may provide a preferred design so as to afford a structure that can be externally cooled and allow the product contained in the center of the tube to be sufficiently cooled.

In an embodiment, the heat exchanger defines a first temperature controlled passage and a second temperature controlled passage through which the meat emulsion passes. Temperatures within the first temperature controlled passage and/or the second temperature controlled passage of the heat exchanger can be controlled by a fluid travelling through a portion of the passage.

The set meat emulsion pieces discharged from the confined processing zone can have the form of long strips of products having a temperature of about 65° C. to 100° C., preferably about 98° C. to about 100° C., and a moisture content of about 47% to 65%, preferably between about 50% to 65%, with the pieces varying in size. Upon discharge from the processing zone, the pieces can be rapidly cooled by evaporating cooling to a temperature in the range of 60° C. to 93° C., preferably 83° C. to 93° C.

If desired, suitable cutting means, such as a rotary cut-off knife, a water jet knife, a knife grid, or the like may be mounted at the discharge end of the elongated tube to cut the product into pieces of a desired size. In an embodiment, the product is cut down the center to allow the product to more rapidly cool. The meat emulsion chunks thus formed have excellent integrity and strength and will retain their shape and fiber characteristics when subjected to commercial canning and retorting procedures such as those required in the production of canned foods having a high moisture content.

To enhance the fibrous image of the product, a set of compression rolls which are two long lightly-toothed cylinders (rolls) that spin at similar speeds can be used. Product discharged from the confined processing zone can be dropped into a narrow adjustable opening between the spinning cylinders which open up/partially separate/tear the fibers. This incomplete shredding can emphasize the linear fibers.

The discharged meat emulsion pieces can be subjected to a number of post-discharge steps. For example, the meat emulsion pieces discharged from the confined processing zone may be conveyed to a dryer to remove a large portion of the moisture therefrom, and the dried product collected and stored. Moisture reduction may also be accomplished by exposing the pieces to dry heat, so that the resultant product pieces, although displaying fibers, have a generally kibble-like appearance. The dry heat may be provided by roasting, baking, grilling or frying the body. Preferably, the body is flash-fried. The duration can be less than one minute and preferably in the range from 15-35 seconds when the oil is in the temperature range from 150° C. to 200° C.

Alternatively, the meat emulsion pieces may be conveyed from the elongated tube directly to a canning operation in which chunks are filled into cans together with other ingredients, such as sauce, gravy, and the like, and the cans retorted. In either situation, the product can be resized if desired.

By way of example, in the production of a canned pet food product, a suitable gravy may be prepared by heating a mixture of water, starch, and condiments. The meat emulsion chunks and gravy can be filled into cans in the desired proportions, and the cans can be vacuum sealed and are then retorted under time-temperature conditions sufficient to effect commercial sterilization. Convention retorting procedures may be used. Typically, a retorting temperature of about 118° C. to 121° C. for about 40 to 90 minutes is satisfactory in producing a commercially sterile product.

In an embodiment, the meat pet food product is fabricated fish chunks having the appearance and texture of real fish. The fabricated fish chunks can comprise from about 75 to about 95% of one or more functional proteins, preferably from about 80 to about 95%, and more preferably from about 85 to about 95%. The functional proteins can comprise from about 40 to about 95% surimi and up to about 55% of non-surimi functional proteins that include the canola protein isolate, combination of flaxseed meal and canola protein isolate, or combination of flaxseed meal and egg white. Preferably the fabricated fish chunks comprise from about 2% to about 10% of the canola protein isolate, combination of flaxseed meal and canola protein isolate, or combination of flaxseed meal and egg white, and more preferably from about 3% to about 7% of the canola protein isolate, combination of flaxseed meal and canola protein isolate, or combination of flaxseed meal and egg white. The fish chunks have a smooth laminar appearance and a flaky texture similar to chunks of real fish.

Non-limiting examples of types of fish that can be used to make surimi are Alaska Pollock, Bigeyes, Big-head Pennah Croaker, Cod, Golden Threadfin Bream, Milkfish, North Pacific Hake, Arrowtooth Flounder, Swordfish, Tilapia, various shark species, and combinations thereof. In a preferred embodiment, the types of fish used to make surimi are one or more selected from Alaska Pollock, North Pacific Hake and Arrowtooth Flounder.

Any functional protein that is capable of producing a gel and that is compatible with surimi can be used in addition to the canola protein isolate, combination of flaxseed meal and canola protein isolate, or combination of flaxseed meal and egg white. Non-limiting examples of suitable additional non-surimi functional proteins include milk protein concentrate, sodium caseinate, soy isolate protein, plasma protein, non-surimi fish protein, other types of white or light colored meat protein, and combinations thereof. Non-limiting examples of suitable non-surimi fish protein is one or more of salmon, tuna, white fish, mackerel, snapper, grouper, herring, or catfish. In a preferred embodiment, the non-surimi fish protein is one or more of salmon or tuna.

The fabricated fish chunks comprise other comestible ingredients. In various embodiments, the fabricated fish chunks comprise from about 5% to about 25% of the other comestible ingredients, preferably from about 5% to about 20%, and more preferably from about 5% to about 15%. The other comestible ingredients can be any material compatible with the functional proteins and capable of forming the fabricated fish chunks with flaky texture. Preferably the other comestible ingredients are animal, plant or vegetable matter. In some embodiments, the other comestible ingredients are fiber, fat, carbohydrate, meal, or combinations thereof.

In various embodiments, the fabricated fish chunks comprise from about 1% to about 10% fat, preferably from about 2% to about 8% fat, and more preferably from about 3 to about 7% fat.

The fabricated fish chunks can be made by heating an emulsion of the ingredients, including the canola protein isolate, combination of flaxseed meal and canola protein isolate, or combination of flaxseed meal and egg white, to a temperature of about 135 to about 170° C., preferably from about 140 to about 160° C., more preferably from about 145 to about 155° C.; and cooling the mixture in a heat exchanger to a temperature from about 60 to about 95° C., preferably from about 65 to about 80° C., more preferably from about 70 to about 75° C. Preferably the heating is performed at increased pressures, for example at pressures from about 60 to about 90 psi, preferably from about 65 to about 80 psi, more preferably from about 70 to about 75 psi. The canola protein isolate, combination of flaxseed meal and canola protein isolate, or combination of flaxseed meal and egg white can be added before and/or after the emulsification.

In some embodiments, the fish emulsion is heated in a extruder with a temperature from about 140 to about 165° C., preferably from about 145 to about 160° C., and more preferably from about 148 to about 155° C., and at pressures from about 225 to about 375 psi, preferably from about 235 to about 350 psi, and more preferably from about 250 to about 320 psi. In some embodiments the heated fish emulsion is cooled in multiple cooling zones. For example, the water in the first cooling zone can have a temperature from about 135 to about 165° C., preferably from about 140 to about 150° C., and more preferably from about 145 to about 155° C. The water in each subsequent cooling zone can be reduced by about 10 to about 20° C. resulting in a water temperature in the final cooling zone from about 25 to about 55° C., preferably from about 40 to about 50° C., and more preferably from about 35 to about 45° C.

In an embodiment, the fabricated fish chunks are dried to a temperature from about 90 to about 275° C., preferably from about 150 to about 235° C., and more preferably from about 160 to about 190° C., and for a time period from about 10 to about 50 minutes, more preferably from about 20 to about 40 minutes, and more preferably from about 25 to about 35 minutes.

### EXAMPLES

By way of example and not limitation, the following non-limiting examples are illustrative of various embodiments provided by the present disclosure.

### Example 1

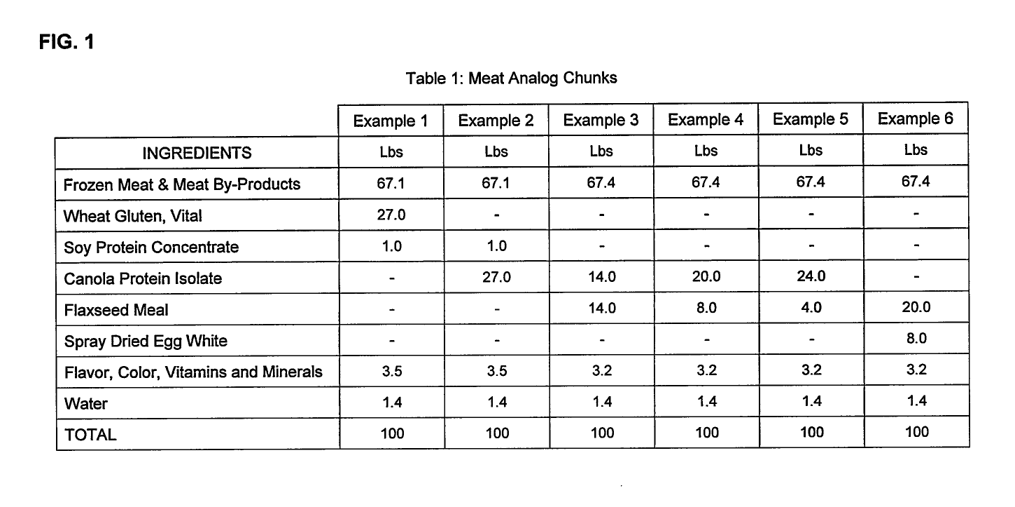

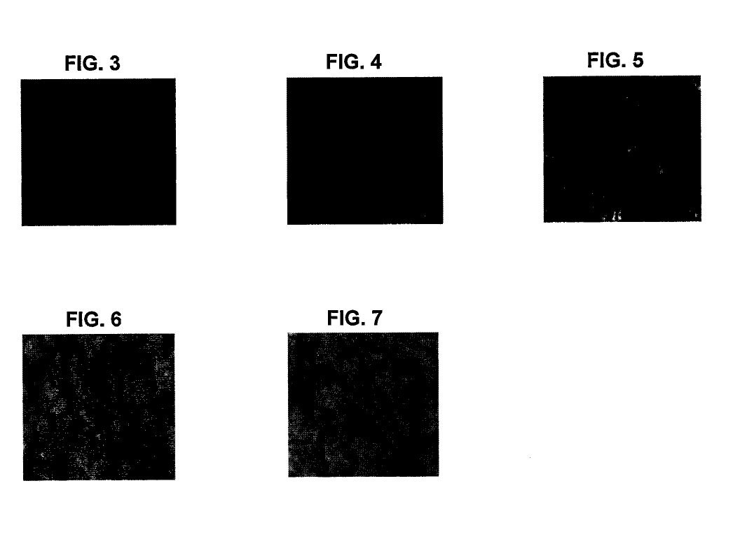

100 lbs. of meat analog chunks were produced with ingredients in the proportions shown in Table 1 in FIG. 1. The frozen meat and meat by-products mixture (67.1 lbs.) and added water were emulsified with an emulsion mill during which the temperature of the emulsified mixture was raised to 100° F. This meat emulsion was then blended with the remaining ingredients colors, flavors, vitamins, minerals, wheat gluten, and soy protein concentrate (Table 1) in a mixer and mixed to form a dough. This dough was then pumped through a Siefer Mill (Siefer Machinenfabrik GmbH & Co.) to achieve a discharge temperature of 320° F. and the pressure maintained below 100 psi. The hot dough mixture was then pumped through a tubular heat exchanger, where the product was cooled from 320° F. to just above the boiling point of water. The material exiting the heat exchanger was texturized into slabs of a fibrous, meat analog product of moisture 55.1%. The slabs were diced, and the resultant chunks are shown in FIG. 3.

### Example 2

100 lbs. of meat analog chunks were produced with ingredients in the proportions shown in Table 1 as for Example 1 except that the wheat gluten (27 lbs.) was replaced by canola protein isolate. Moisture of the texturized slabs exiting the heat exchanger was 54.8%. The image and texture were similar to product of Example 1. The slabs were diced, and the resultant chunks are shown in FIG. 4.

### Example 3

100 lbs. of meat analog chunks were produced with ingredients in the proportions shown in Table 1 as for Example 1 except that the wheat gluten (27 lbs.) and soy protein concentrate (1 lb.) were replaced by canola protein isolate (14 lbs.) and flaxseed meal (14 lbs.). Moisture of the texturized slabs exiting the heat exchanger was 54.4%. The image and texture were similar to product of Example 1.

### Example 4

100 lbs. of meat analog chunks were produced with ingredients in the proportions shown in Table 1 as for Example 3 except that the amount of canola protein isolate was 20 lbs. and the flaxseed meal amount was 8 lbs. Moisture of the texturized slabs exiting the heat exchanger was 55.4%. The image and texture were similar to product of Example 1.

### Example 5

100 lbs. of meat analog chunks were produced with ingredients in the proportions shown in Table 1 as for Example 3 except that the amount of canola protein isolate was 24 lbs. and the flaxseed meal amount was 4 lbs. Moisture of the texturized slabs exiting the heat exchanger was 53.9%. The image and texture were similar to product of Example 1.

### Example 6

100 lbs. of meat analog chunks were produced with ingredients in the proportions shown in Table 1 as for Example 4 except that the canola protein isolate (20 lbs.) was replaced by 8 lbs. of spray dried egg white and the flaxseed meal amount was increased to 20 lbs. Moisture of the texturized slabs exiting the heat exchanger was 53.2%. The image and texture were similar to product of Example 1. The slabs were diced, and the resultant chunks are shown in FIG. 5.

### Example 7

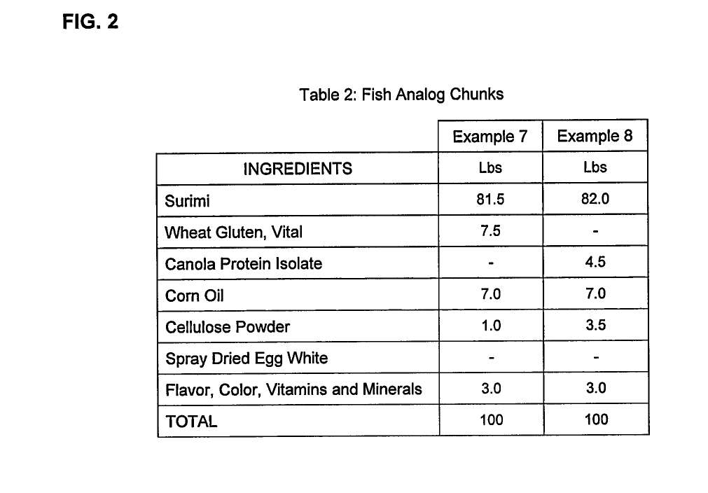

100 lbs. of a fish analog chunk was made based upon the formulation shown in Table 2 in FIG. 2. The frozen surimi block was run though a Weiler grinder with 0.25 inch plate. The ground surimi was then mixed in a blender where steam was injected during mixing until the surimi temperature reached about 15° C. Once the surimi reached temperature the other ingredients were added and mixed for 5 minutes to form a dough. The final dough was 65.1% moisture. This dough was pumped using a stuffer into an emulsifier. The pressure at the discharge end of the emulsifier was controlled with a high pressure pump within a range of 74-80 psi. This pressure along with the mechanical shear of the emulsifier resulted in a temperature increase of the emulsified dough to a range of 147-153° C. The emulsified dough was then cooled to less than 100° C. in a plate heat exchanger and exited the heat exchanger in large slabs about 8-10 inches long with smooth laminar appearance. The slabs were diced, and the resultant chunks are shown in FIG. 6.

### Example 8

100 lbs. of a fish analog chunk was made based upon the formulation shown in Table as for Example 7 except that wheat gluten (7.5 lbs.) was replaced by 4.5 lbs. canola protein isolate; the cellulose powder was increased to 3.5 lbs.; and the surimi increased to 82.0 lbs. The slabs were diced, and the resultant chunks shown in FIG. 7 where it is seen that the image and texture are as good as those in Example 7.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A pet food product comprising emulsified meat material and an ingredient selected from the group consisting of (i) canola protein isolate, (ii) a combination of flaxseed meal and canola protein isolate, and (iii) a combination of flaxseed meal and egg white, and the product does not contain wheat gluten.

2. The pet food product of claim 1 comprising at least 29% protein by weight of the product.

3. The pet food product of claim 1 comprising up to 15% fat by weight.

4. The pet food product of claim 1 wherein the emulsified meat material is from at least one source selected from the group consisting of poultry, beef, pork and lamb, and the ingredient is present in an amount of about 5% to about 35% by weight of the product.

5. The pet food product of claim 1 wherein the emulsified meat material comprises surimi, and the ingredient is present in an amount from about 2 to about 10% of the product.

6. The pet food product of claim 1 wherein the product is gluten-free.

7. A method of making a pet food product that does not contain wheat gluten comprising:
performing an emulsification of meat material to form a meat emulsion that does not contain wheat gluten;
comminuting and heating the meat emulsion;
subjecting the meat emulsion to an increased pressure; and
adding to the meat material, at a time selected from the group consisting of before the emulsification, after the emulsification, and a combination thereof, an ingredient selected from the group consisting of (i) canola protein isolate, (ii) a combination of flaxseed meal and canola protein isolate, and (iii) a combination of flaxseed meal and egg white.

8. The method of claim 7 wherein the meat material is from at least one source selected from the group consisting of poultry, beef, pork and lamb, and the ingredient is present in an amount of about 5% to about 35% by weight of the emulsion.

9. The method of claim 7 wherein the meat material comprises surimi, and the ingredient is present in an amount from about 2 to about 10% of the emulsion.

10. The method of claim 7 wherein the heating is performed at a temperature of at least 132° C.

11. The method of claim 7 wherein the increased pressure is at least 100 psi.

12. The method of claim 7 further comprising a step performed after the increased pressure and selected from the group consisting of (i) dicing the meat emulsion into chunks and blending the chunks with another pet food product, (ii) cutting the meat emulsion into pieces that are dried to a moisture content less than 12% and then coated with flavorants, (iii) forming shelf-stable soft treats by cutting the meat emulsion into pieces that are dried to a moisture content less than 25% and then coating the pieces, and (iv) dicing the meat emulsion into chunks, drying the chunks to a moisture content less than 12%, and blending the dried chunks with another pet food product.

13. The method of claim 7 wherein the meat emulsion is gluten-free.

14. A method of making a pet food product that does not contain wheat gluten, comprising replacing wheat gluten in a meat emulsion with an ingredient selected from the group consisting of (i) canola protein isolate, (ii) a combination of flaxseed meal and canola protein isolate, and (iii) a combination of flaxseed meal and egg white, and forming the pet food product that does not contain wheat gluten by processing the meat emulsion.

15. The method of claim 14 wherein the ingredient is substituted for the wheat gluten in a 1:1 weight ratio or less.

16. The method of claim 14 wherein the meat emulsion is gluten-free.

17. A method of making a pet food product that does not contain wheat gluten comprising:
forming a mixture comprising surimi and an ingredient selected from the group consisting of (i) canola protein isolate, (ii) a combination of flaxseed meal and canola protein isolate, and (iii) a combination of flaxseed meal and egg white, and the mixture does not contain wheat gluten;
blending the mixture while increasing a temperature of the mixture; and
cooling the blended mixture to produce fish chunks that do not contain wheat gluten.

18. The method of claim 17 wherein the temperature is increased to about 135 to about 170° C. during the blending.

19. The method of claim 17 wherein the blended mixture is cooled to a temperature from about 60 to about 95° C.

20. The method of claim 17 wherein the mixture is gluten-free.

21. The method of claim 17 wherein the ingredient is present in an amount from about 2% to about 10% of the mixture.
